(19) United States
(12) Patent Application Publication
(10) Pub. No.: US 2008/0092147 A1
(43) Pub. Date: Apr. 17, 2008

(54) Method for Determining Deadlocks in Secondary Processes

(75) Inventor: Michael Kersten, Baldham (DE)

Correspondence Address: HARNESS, DICKEY & PIERCE, P.L.C., P.O.BOX 8910, RESTON, VA, 20195, US

(73) Assignee: SIEMENS AKTIENGESELLSCHAFT, Munchen (DE)

(21) Appl. No.: 11/579,554

(22) PCT Filed: May 2, 2005
(86) PCT No.: PCT/EP05/51986

§ 371 Date: Nov. 3, 2006

(30) Foreign Application Priority Data
May 4, 2004 (DE) 10 2004 021 975.3

(51) Int. Cl. G06F 9/54

(52) U.S. Cl. 719/316

(57) ABSTRACT

Disclosed is a method for determining deadlocks in secondary processes for a system model that is described in an object-oriented manner. The method includes the following: a) all active objects of the object-oriented system model are extracted; b) the transitions between the objects are identified; c) the state-waiting relations between the objects are established; d) potential deadlocks are determined as cycles of entities of two or more different objects, which wait for each other; and e) for each deadlock, all potential paths resulting in a determined deadlock are verified by way of a simulated execution of the system model.

### PRIORITY STATEMENT

This application is the national phase under 35 U.S.C. § 371 of PCT International Application No. PCT/EP2005/051986 which has an International filing date of May 2, 2005, which designated the United States of America and which claims priority on German Patent Application number 10 2004 021 975.3 filed May 4, 2004, the entire contents of which are hereby incorporated herein by reference.

### FIELD

The invention generally relates to a method for determining deadlocks in secondary processes. For example, it may relate to one using a system model of a reactive system that is described in an object-oriented manner, whereby at least one object in one state waits for a different object in a specific state.

### BACKGROUND

The Unified Modeling Language UML has developed to become a standard modeling language in the field of object-oriented design for the development and design of reactive systems. This graphic object-oriented, computer-implemented language enables not only software programs but also complex technical systems, such as motor vehicles and aircraft, to be described and their functions verified. Because of the high-safety requirements in these fields, the combination of a standard modeling language with formal methods is desirable in order to be able to reliably identify malfunctions in the design phase. Deadlocks can also occur in cyclical processes in such systems.

In informatics, a deadlock is a state of processes in which as least two processes each wait for operating means that in each case is assigned to the other process. Because of this, both processes block each other. A deadlock can then only be removed by ending individual processes or restarting the system. Both courses of action can be very problematic in safety-critical systems.

Deadlocks can occur in systems that are capable of allowing several processes to run in parallel (multitask systems) and in which the sequence of the operating means allocation is not specified.

T. Schafer, A Knapp and S. Merz: “Model Checking UML State Machines and Collaborations”, in: Electronic Notes in Theoretical Computer Science 47 (2001), pp. 1-13, for example, describes a method for verifying freedom from deadlocks and other model properties for relatively small systems using the method of model checking. These are specialized computer programs that have the disadvantage of requiring a transformation of the system into a model checker input language. Furthermore, each state of a state machine is modeled by an individual process. For each state machine of the UML system model two additional processes serve to output events, stored in an event queue, and to handle transitions.

However, an expensive transformation into the available modeling language, with a severely limited modeling power, is required for checking object-oriented system models. Allowing for the data types of object-oriented models, that require a very large state space, is also a considerable problem. This reduces the size of the system model that can be checked.

### SUMMARY

At least one embodiment of the invention creates an improved method for identifying deadlocks in secondary processes for system models of reactive systems that are described in an object oriented manner.

The method, in at least one embodiment, is achieved by the following:
a) The extraction of all active objects of the object-oriented system model.
b) Identifying at least the events consumed and/or produced by the objects, the transitions between the objects and of guard conditions of state machines of the UML system model for describing the system model to describe the state behavior of the objects.
c) Establishing the state-waiting relations between the active objects from the events, as a list of objects that wait in a defined state for a different object in a defined state.
d) Determining potential deadlock situations as cycles of entities of two or more different objects waiting for each other, and for each deadlock, with no object having more than one state being involved in the cycle and no object of the cycle waiting for an object outside the cycle.
e) Checking all potential paths that result in a determined deadlock and from which the state machines of the UML system model can be derived, by means of a simulated execution of the system model taking account of events and activated transitions, for analysis of the attainability of the determined potential deadlock.

By way of a method of this kind, it is possible to verify the freedom from deadlock for models of object-oriented systems of technically reactive systems with many parallel components, taking account of complex data types.

A multistage method of checking is proposed by at least one embodiment of the invention. In steps a) and b), the properties of a system model relevant for a deadlock are extracted and from these, in step c) a state-waiting diagram is established, that can be subsequently analyzed to determined which “wait-for” relationships exist between active objects. Furthermore, the internal states of active objects are described.

In a second phase, the potential deadlock situations are determined. If no deadlock situations were found, the process is terminated and the results can be shown. Otherwise, in a third phase, the attainability of the determined potential deadlock situations is analyzed by using a search algorithm to calculate the possible paths of the determined potential deadlock situations found in the preceding phase. An analysis is then carried out to determine whether these paths can be executed by way of a heuristic simulation.

Active objects within the meaning of embodiments of the invention are language devices used in the system modeling language to describe processes. An active object in the object-oriented model corresponds to a secondary process of the modeled technical reactive system. A secondary process can under certain circumstances be cyclic. This is frequently the case with reactive systems but not a necessary condition for the application of at least one embodiment of the method.

In step a) of the extraction of all active objects, the active objects are extracted from a static and dynamic structural aspect of the system model and stored in an object list.

It is advantageous if for each actual object an assigned class is stored in a class list and for each class in the class list the associated state diagram is evaluated to specify a state machine. The specified state machines can then be stored in a state machine list.

In this way, a mathematical list structure is created that enables an effective analytical evaluation.

The potential deadlock situations are preferably determined using a known depth-search method (depth-first search).

The verification of the attainability of the determined potential deadlock situations is preferably carried out heuristically, in that, starting from an initial state of the system model, the activated transitions in each case are determined and those activated transitions that bring the system model nearer to the deadlock event are selected.

Activated transitions are, for example, then present if the guard condition for the assigned object is true and the event of the object is in an input waiting queue.

Preferably, the checking of all possible paths for every deadlock situation (phase C) is repeated iteratively in step e) until either a deadlock state is reached or all paths have been checked a specified number of times.

The system model is described, especially preferably using the Unified Modeling Language UML.

At least one embodiment of the invention furthermore includes a computer readable medium including a computer program with program code segments for performing the method described above, if the computer program is executed on a computer.

### BRIEF DESCRIPTION OF THE DRAWINGS

The invention is explained in more detail in the following, by way of an example embodiment and using the accompanying drawings. These show:

FIG. 1 Flow diagram of the method in accordance with an embodiment of the invention for determining deadlocks;

FIG. 2 Static system structure (class diagram) of an example of a measuring system model;

FIG. 3 Dynamic system structure of an example of the measuring system model from FIG. 2;

FIG. 4 A detail view of the behavior of the controller of the example of the model of the measuring system;

FIG. 5 Detail view of the behavior of the first sensor of the example of the model of the measuring system;

FIG. 6 Detail view of the behavior of the second sensor of the example of the model of the measuring system;

FIG. 7 Detail view of the behavior of the clock of the example of the measuring system model;

FIG. 8 Detail view of the behavior of the user of the example of the measuring system;

FIG. 9 State-Waiting graph of an example of a run to identify potential deadlocks;

FIG. 10 Sequence diagram showing the results of the analysis of the method in accordance with an embodiment of the invention using a measuring system model as an example.

### DETAILED DESCRIPTION OF THE EXAMPLE EMBODIMENTS

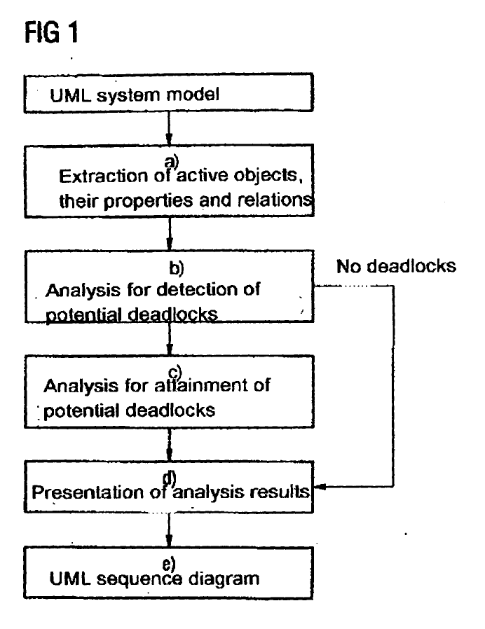

FIG. 1 shows a flow diagram of the multiphase method according to an embodiment of the invention for determining deadlocks in secondary processes.

The starting point is a system model that is graphically, and in an object-oriented manner, described using the Unified Modeling Language UML, referred to in the following as the UML system model. The method is equally suitable for other descriptive languages that describe technical systems in an object-oriented manner.

In a first phase a), the active objects of the UML system model and the properties and relations of same are extracted. The properties of the UML system model relevant for a deadlock are furthermore extracted and stored in mathematical structures, such as lists, sets and tuples that enable an evaluation with an effective algorithm in the succeeding phases.

During the extraction, all active classes of the UM system bottle are analyzed with respect to their communication properties. In practice this means that for each active class a record of generated events and consumer-events is calculated and stored in generator-event lists and consumer-event lists. In this respect, call-events are regarded as consumer-events and call actions as generators of events. Events are then considered only if their generators and consumers are suitably associated.

In a second phase b), an analysis is performed to identify potential deadlock-events. This analysis can be by way of a static evaluation of a UML state diagram, to determine which wait-relations exist between the active objects. To do this, a state-waiting graph is inserted that, in contrast to the standard wait graphs, reflects the internal state of active objects. The detection of cycles in the state-waiting graph initiates the existence and location of potential deadlocks.

A potential deadlock is a cyclical wait situation between concurrent or parallel components of a system, that in each case are within a specific state. The potential deadlocks can be identified in a state-waiting graph. This is an oriented graph in which each node represents an active object in a specific state (of the assigned state diagram) and each edge a “wait-on” relation. The number of peaks of the state-waiting graph is the same as the number of states of all state diagrams of the model that are assigned to active classes. The number of edges depends on the transitions defined in these state diagrams. The head of each edge is connected to a node waiting for a specific event. The node connected to the end of the edge is a potential originator of this special event.

The analysis of potential deadlock situations starts with the generation of a state-waiting graph. This is achieved by calculation in the phase of extraction of active objects and their properties and relations, for example by calculating consumer and producer lists. After generation of the complete state-waiting graph of the system, potential deadlock situations can be detected. A potential deadlock situation is a situation in which two or more objects in a specific state are each waiting for the generation of a certain event.

With the method according to an embodiment of the invention, in phase b) all cycles in the state-waiting graph are then detected and the relevant cycles sorted out. Furthermore, cycles are not potential deadlocks but instead logic errors in the corresponding state diagram where all nodes of the cycle are the same object. Cycles with two or more nodes of different objects are on the other hand potential deadlock situations if no object with more than one state in a cycle is involved. Otherwise there are cycles with “overinvolved” objects. All cycles in the state-waiting graph are detected by means of an improved algorithm, called a depth-first search algorithm, that calculates all cycles of the graph and the distribution in a single run.

Logic errors and cycles with “overinvolved” objects are detected by using set operations. The remaining potential deadlock situations are then examined with respect to the outgoing edges. This is achieved by moving across the graph and calculating the starting degree of each node. The starting degree is the number of edges going out from the node. If all nodes have a starting degree of one, a potential deadlock situation is present within the meaning of embodiments of the invention.

If nodes with a starting degree of more than one are present, whether the investigated cycle is a potential deadlock or not depends on the target object of the edge pointing outwards from the cycle. If the target object is not involved in the cycle under investigation, the investigated cycle is not a deadlock. Otherwise, a check must be carried out to determine whether the edges connect two states of the same object.

If this check reveals that the edges connect two states of the same object, the potential deadlock is combined with a logic error and the logic error should be corrected before the deadlock identification is continued. Otherwise, a further cycle in the state-waiting graph is identified that is to be subsequently evaluated. In this case, the next phase c) can be initiated because the cycle detection ensures that all cycles are found and processed separately in a further analysis of the attainability of the potential deadlock situation.

A potential deadlock situation means that it is statistically possible for a deadlock to occur. However, whether the deadlock event actually occurs during the run time depends on dynamic aspects of the system model that are investigated in the next phase c) of the analysis of the attainability of potential deadlock situations, separately from phase b) of the analysis for identifying potential deadlock situations.

If no potential deadlock situation is found in phase b), the system is deadlock-free and the next phase c) can be skipped.

The attainability of the potential deadlock situations is then analyzed in phase c). To do this, each potential deadlock situation identified in phase b) is investigated, in that the possible paths in the potential deadlock situations are calculated using a search algorithm and then further analyzed using a heuristic simulation approach, to determine whether these paths can be executed. The search algorithm performs a specialized depth-search for each relevant state diagram and saves all the paths for potential deadlock situations in a path list. Each path list contains all the states and transitions of the respective path.

The path lists are used as input data for the succeeding heuristic simulation. In the simulation, the state machines of the UML system model are executed by means of a simulator that implements the precise UML semantics according to the OMG standard (www.omg.org). In addition to very special features such as the waiting queue length and the investigation sequence of the expressions defined in the semantics, the following aspects of the model must be considered.

Guard conditions, event parameter values and attribute values.

In a case where one or more paths are present in a potential deadlock situation, it is sufficient to find an executable path during the simulation. The other case is essentially more expensive. When all paths of the path list have been executed once and no executable path was found it cannot be determined from this whether an executable path is present or not. Even after a theoretically infinite number of executions, it cannot be stated with absolute certainty that the next execution will not lead to a potential deadlock situation. It is therefore proposed to discontinue the simulation after a specified number n of executions.

The disadvantage of this heuristic simulation approach is that the non-existence of deadlocks cannot be verified if potential deadlock situations are present that cannot be attained in phase c), i.e. for which no executable path was found after n number of simulations. In this exceptional situation, the only remedy is to check the model by an expensive search through a completely unfolded state space.

The results of the analysis are presented in the final phase d). This can, for example, be by way of an expanded UML sequence diagram.

The method according to an embodiment of the invention is described in the following using an example of a measuring system model consisting of a first and second sensor Sensor1 and Sensor2, a control unit Controller and a clock. The sensors Sensor1 and Sensor2 have a measuring unit that performs the actual measurement and deduces their behavior in the measuring system model. The clock has a timing device that models the progress of time and feeds back the current time point when called. A deduction from the exact functioning of the clock is also made in the measuring system model. The clock is required by sensors Sensor1, Sensor2 to provide the measured values with time stamps. The control unit Controller is responsible for starting the components and continuously interrogates both sensors Sensor1, Sensor 2 during the runtime of the system. The system can be started and stopped by the user. The behavior of the user can be modeled for analysis purposes.

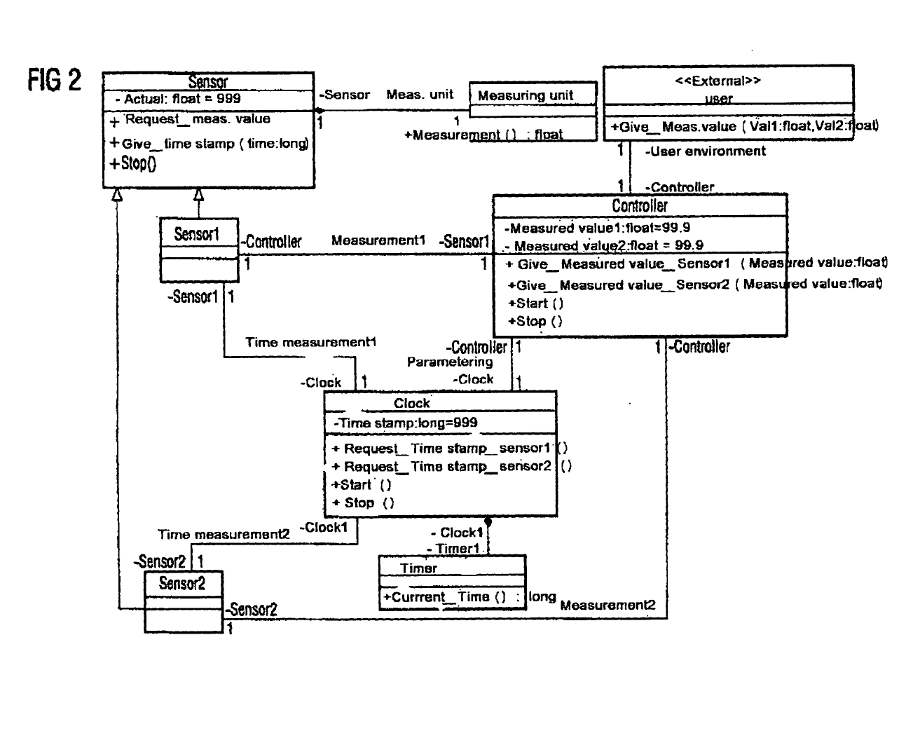

FIG. 2 shows the static system structure of the measuring system model as a class diagram.

The + and − signs used in the class diagram represent the visibility of the element they precede. All elements annotated by “+” (operations and/or attributes) are declared to be public. These are visible to all other classes associated with the relevant class. Elements annotated by “−” are private and therefore visible only within the relevant class, i.e. the private elements can be called from the class itself, for example in the associated state diagram, but not from other classes.

In the example, all operations are declared to be of the public class, i.e. annotated with “+”. Only the attributes that are used to save values are declared private “−”. This corresponds to the principle of secrecy in object-oriented modeling and has the effect of enabling the values of the attributes of classes to be manipulated only by their operations, and thus limits the danger of side effects.

It is clear that the user in the request “Give_Measured Value” requests two values Value1, Value2, that he receives back from the controller as parameters. The controller starts the measuring process with the instruction “+Start( )” and requests measured values from the first and second sensors Sensor1, Sensor2 (Give_Measured Value_Sensor1, Give_Measured Value_Sensor2).

The request is passed via the sensor components to the measuring unit that performs the actual measurement, with a time stamp being requested from the clock at each measurement for each sensor Sensor1, Sensor2 by means of the instruction “Give_Time Stamp”. The measured values are sent back via the sensors Sensor1, Sensor2, together with a time stamp, to the controller and from there to the user.

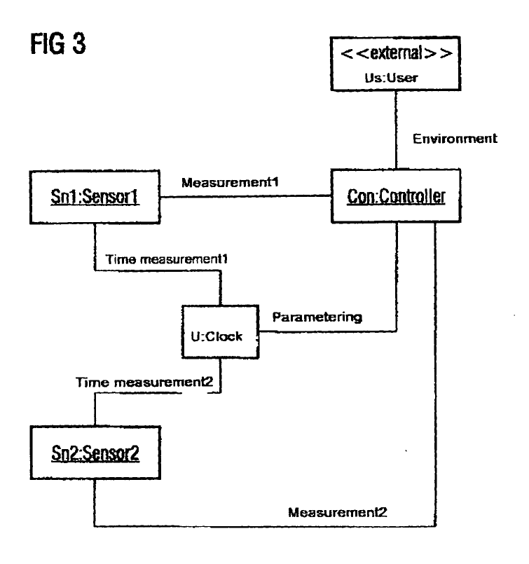

FIG. 3 shows a block diagram of the dynamic system structure of the measuring system model. It is clear that the controller is used for parameterizing the clock that in turn performs the time measurements Time Measurement1, Time Measurement2 during the measurement by sensors Sensor1, Sensor2. The measured values are sent back together with the time stamp as signals Measurement1, Measurement2 to the controller and from there to the environment of a user.

The behavior of the individual system elements is as follows:

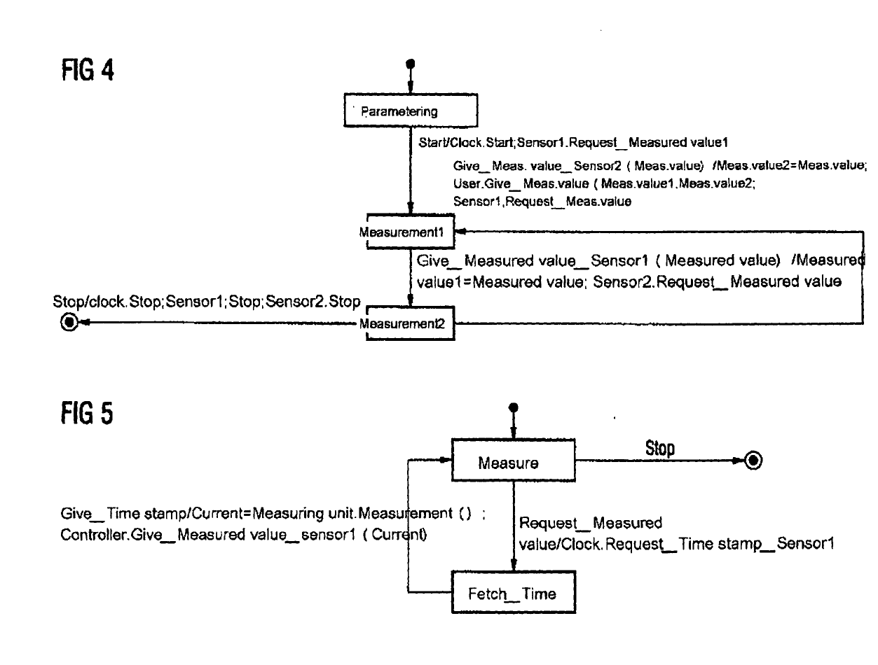

FIG. 4 is a diagram showing the behavior as viewed by the controller. After initialization, the controller parameterizes the clock and starts said clock with the instruction “Start/Clock.Start”. Furthermore, the first measurement (Measurement1) is initiated by the instruction “Sensor.Request_Measured Value”. The measured value of the first sensor is then requested (Give_Measured Value_Sensor1 (Measured value)/Measured value1:=Measured value) and the second measurement (Measurement2) is initiated by the second sensor (Sensor2) with the instruction “Sensor2.Request_Measured Value”. From the second measurement (Measurement2) a feedback to the first measurement (Measurement1) takes place with the requests “Give_Measured Value_Sensor2 (Measured value)/Measured value2:=Measured value) of the renewed request of the measured value to Sensor1 by the instruction “Sensor1.Request_Measured Value) and, if appropriate, the forwarding of the measured values to the user by the instruction “User.Give_Measured Value (Measured value1, Measured value2)”.

This loop is run until the stop signals for the clock, for Sensor1 and for Sensor2 are output (Stop/Clock.Stop); Sensor1.Stop;Sensor2.Stop).

FIG. 5 shows the behavior as seen by Sensor1. After initialization, the measurement takes place with a request to the clock for the time stamp using the instruction “Request_Measured Value/Clock.Request_Time stamp_Sensor1”. The result of the Fetch_Time state is the forwarding of the time stamp to the Sensor1 for linking with the measured value Sensor1 (Give_Time Stamp/Current:=Measuring unit.Measurement ( ); Controller.Give_Measured Value_Sensor1 (Current),

The “Measure” state is ended on receipt of the “Sensor1.Stop” stop signal.

FIG. 6 shows a corresponding view of the behavior as seen by Sensor2. For an explanation refer to the previous description.

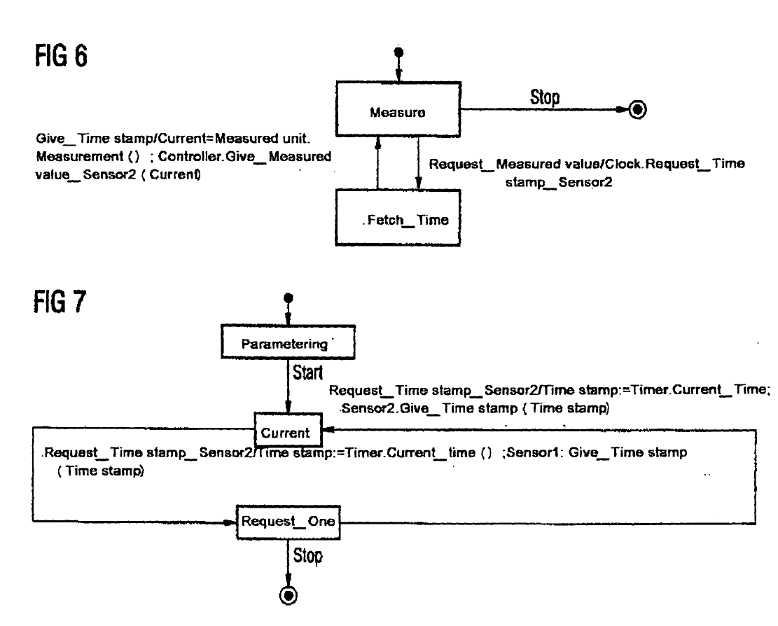

FIG. 7 shows the behavior as seen by the clock. After initialization, the state of parameterizing of the clock by the controller takes place and an ongoing “current” state is initiated by the “Start” signal. This state gives a timestamp to Sensor1 (Sensor1.Give_Time Stamp (Time stamp)) and answers the request for a time stamp by Sensor2 by setting the time stamp to the current clock time of the timer (Request_Time Stamp_Sensor2/Time stamp:=Timer.Current_Time ( )). As long as a “Request_{—}1” state still detects a request for a time stamp by one of the sensors Sensor1, Sensor2, the time stamp for Sensor2 is determined using the instructions “Request_Time Stamp_Sensor2/Time stamp:=Timer.Current_Time” and a time stamp is assigned to Sensor2 by means of the instruction “Sensor2.Give_Time stamp (Time stamp)”.

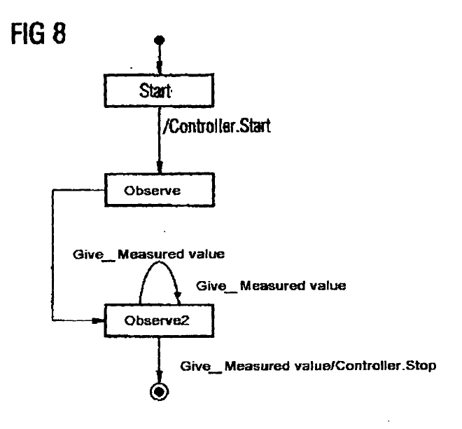

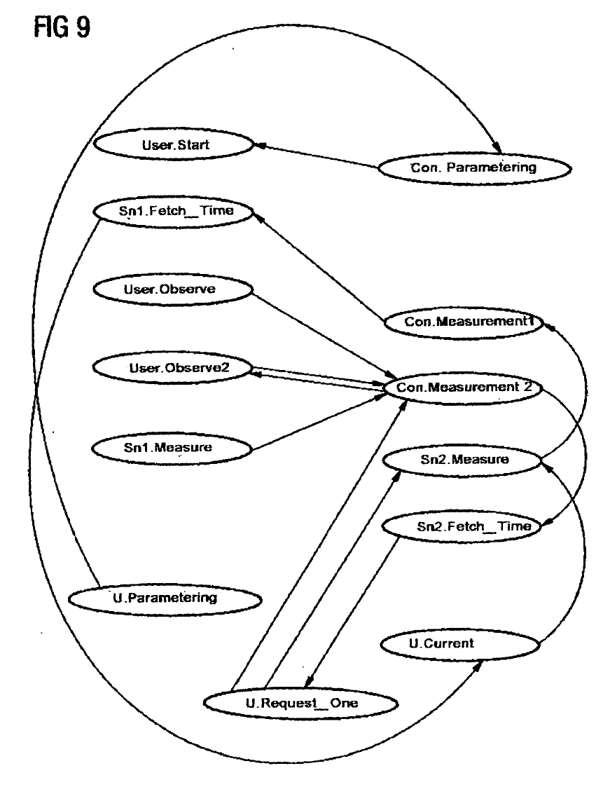

Otherwise, the state is stopped by way of the “Stop” instruction. The behavior as seen by the user is shown in FIG. 8. After initialization, the state is started in the “Start” state by way of the “Controller.Start” instruction to the control unit and the “Observer” state is called up by requesting the “Give-Measured value” event from the control unit. In the succeeding “Observer2” state the measured value is awaited from the control unit and further measured values requested from the control unit in a loop by the request “Give-Measured value”. The state is ended by the instruction “Controller.Stop” to the control unit.

This example of a measuring system model is now described in detail for phases a) to d) with reference to FIG. 1.

In phase a) of the multiple extraction, the features required for deadlock detection are extracted from the UML system model and stored in the structures shown in the following.

Firstly, the components of the system to be covered by the analysis are determined by taking account of the static and dynamic structure (class and object diagram). Because this depends on the type of UML system model, the UML system model must be present in a special form (UML dialect). In this example, a deduction is made from the generation of individual components of the system. It is assumed that at the start of the complete system all active objects are generated and have all the properties that were modeled in the class diagram for the associated classes. The links (entities of the association between the classes) between the objects have the properties carried by the relevant associations in the class diagram.

Furthermore, when considering objects as entities, the objects assigned thereto by composition relationships are also regarded as entities. Therefore, all the objects shown in the object diagram are precisely those to be considered in the detection.

Depending on the field of application of the unified modeling language or corresponding UML profile, this part of the feature extraction can turn out differently. This is, however, not the object of embodiments of this invention.

After all active objects have been extracted from the object diagram and stored in an object list, this list is run through precisely once and the class associated with each object is stored in a class list. The length of the class list is stored as Number_Classes. Then, for each class in the class list, i.e. the active classes, the associated state diagram is analyzed and the state machine specified therein is stored in the state machine list.

All objects are then investigated for their produced actions using the assigned classes in the class list. To do this, the correct state machine must be selected in each case from the state machine list and all transitions investigated in turn. Each transition can trigger any number of actions from 0 to n. Of the various types of actions defined in the UML language, only the call actions are considered by the method. Furthermore, the method can also consider send actions as an option. Because as a rule only one of the two types of actions is used, depending on the type of modeling, the following description of the method covers only the call actions.

The call actions found are stored in an action table, constructed as follows.

| | |
|---|---|
| Object | Action |
| Object 1 | {[state, target object, target event],...} |

The object name can here be found in the action table under the Object entry and a set of actions from 0 to m under the Action entry, that in each case consists of the component state, target object and target result. The number m is the number of actions that can be triggered by a transition. The state is the state of the state machine in which the object can generate the action if the associated transition switches. The target object is the object to which the call action is addressed. The target event is the event of the target object that is generated during this and placed in its input queue.

A wait set table is then generated. This is generated in that for each object from the object list the associated state machine is selected from the state machine list by way of the associated class from the class list, and the event the object is waiting for and in what state and what object the respective event can generate are determined. The information regarding what object the particular event can generate is taken from the actions table.

The wait set table has the following form:

| | |
|---|---|
| Object | Wait set |
| Object 1 | [State 1, (Object 2. State 1, Object 2. State 2)], |

[State 2, (Object 3. State 2)]...

The object name is listed here under the object entry, similar to an action table. The wait set is structured so that a set of object state combinations can be stored for each state of the state machines of the object. An object state combination takes the form “Object. State”, whereby “Object” in this case represents the object that is awaited and “State” the state that is awaited.

In the above table, for example, the Object 1 is waiting in State 1 for Object 2 in State 1 and Object 2 in State 2. As with every other set in the mathematics, the wait set is also free of duplicates.

After generation of the wait set table, all the events of the feature extraction are combined in a “Model features” structure that permits efficient access to all features and makes them available in the other phases b), c) and d).

For the measuring system model in the example, the results of the feature extraction are as follows:

Number of classes=5

Object list=[User->Object, Con=Object, Sn1->Object, Sn2->Object, U->Object].

Class list=[User->Class, Controller->Class, Sensor1->Class, Sensor->Class, Clock->Class].

Action tables:

| | |
|---|---|
| Object | Action |

User ([Start, Con, Start])
Con ([ Parameterizing, U, Start], [Measurement1, Sn2,
Request_Measured Value], [Measurement2 , User, Give_Measured
Value], [Measurement2, Sn1, Request_Measured Value],
[Measurement2, Clock, Stop], [Measurement2, Sn1, Stop],
[Measurement2, Sn2,Stop]).

Sn1
([Measure, U, Request_Time Stamp_Sensor1], [Fetch_Time, Con,
Give_Measured Value-Sensor1])
Sn2 ([Measure, U, Request_Time Stamp,_Sensor2], [Fetch_Time,
Con, Give_Measured Value, Sensor2])
U ([current, Sn1, Give_Time Stamp], [Request_One, Sn2, Give_{—}
Time Stamp])

Wait set table:

| | |
|---|---|
| Object | Wait set |

User [Observe, (Con, Measurement2)], [Observe2,
(Con, Measurement 2)]
Con [Parameterizing, (User.Start)], [Measurement1,
(Sn1.Fetch_Time)], [Measurement2, (User.Observe2)]
Sn1 [Measure, (Con.Measurement2)], Fetch_Time (U.Current)]
Sn2 [Measure, (Con.Measurement1)], {Fetch_Time,
(U.Request_One)]
U [Parameterizing, (Con.Perametering)], [Current,
(Sn2.Measure)], [Request_One, (Sn2.Measure,
Con.Measurement2)].

After the wait set table has been compiled, these features are brought together in the “Model Features” structure and made available to the other phases b), c) and d) of the process. An efficient access to the various features is thus enabled.

In phase b) “Potential deadlock detection”, a state-wait graph is generated from the wait set table. This is a graph the nodes of which represent object-state combinations and the edges of which represent “Wait-for” relations. From this graph, conclusions, such as Object 1 waiting in State 1 for Object 2 and State 1, etc can be drawn. Similar to the wait sets, the edge sets of graphs are also duplicate-free. This simplifies the use of algorithms on graphs and reduces their complexity.

A potential deadlock situation with the method considered here is a cyclic “Wait-for” relationship with some other properties.

Phase b) of the analysis for identifying potential deadlock situations operates in two stages. In the first stage, cycle detection is performed on the basis of the state-wait graph. The result is a set of potential deadlocks. In the second stage, those potential deadlocks that have the following properties are sorted from the set of potential deadlocks.

a) An object with several states is participating in the deadlock;

b) An edge to an object exists that is not participating in the deadlock;

c) Only one object is participating in the deadlock.

All the deadlock situations that have not been sorted out form the final set of potential deadlocks.

The method of cycle detection is based on the generally known depth-first search method.

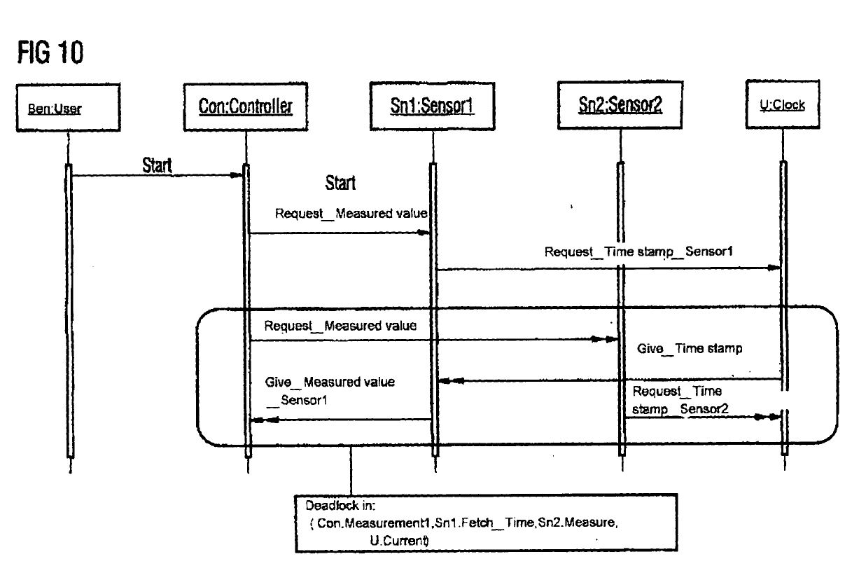

FIG. 9 shows an example of a state-wait graph for the measuring system model.

After the cycle detection, the set of potential deadlocks is as follows:

((User.Observe2, Con.Measurement2), (Con.Measurement1, Sn1.Fetch_Time, U.Current, Sn2.Measure))

After the sorting, the set of potential deadlocks is reduced as follows:

((Con.Measurement1,Sn1.Fetch_Time, U.Current, Sn2.Measure))

The potential deadlock situation (User.Observe2, Con.Measurement2) was sorted out because one edge in the state-wait graph of Con.Measurement2 exists after Sn2 Fetch_Time and therefore the above condition b) is fulfilled for it, i.e. that an edge to an object exists that is not participating in the deadlock.

In the next phase c), the final set of potential deadlocks is passed for analysis of the attainability of the potential deadlock events.

The “deadlock attainability analysis” is used to verify that the potential deadlocks found can be attained in the runtime of the system. In this case also there are various standard procedures that can be used for the attainability analysis. Particularly important for this present method is that the run time advantages resulting from the extremely favorable time complexity are not wasted in the phase of the deadlock attainability analysis. The time required progresses in a predictable linear manner relative to the number of edges and nodes of the state-wait graph.

For this reason, the attainability analysis is heuristically used in phase c). In addition to the events and actions at the transitions, guard conditions of the state machines are also considered.

The first step of the analysis of the attainability of the potential deadlock events is a calculation of local paths of the participating objects. For this purpose, path lists are constructed that can be derived from the state machines of the model. The implementation of the model is then simulated in that, starting from the initial state of the model, checking is carried out to determine which transitions are activated in each case, i.e. which transitions can switch. Transitions can then switch precisely if the guard condition is true and the event lies in the input queue. A suitable heuristic of the particular transitions that brings the model nearer to the potential deadlock situation is then selected.

The simulation is discontinued if the potential deadlock situation is reached or all paths of a specified number n have been run through and no potential state of deadlock could be attained. In the latter case, no inference can be drawn as to whether the potential state of the deadlock can still be attained.

During the attainability analysis, path lists and trace sets are generated. The path lists take the following form:

Pathlist={[Z1, Z2), . . . , (Zi, Zj)], . . . },

with (Z1, Z2) being an assigned pair, whereby the source state of a transition is assigned to Z1, Z2 represents the target state of the transition and Zj lies in the set of potential deadlock situations.

A model state for a model with a number n of objects is given by

<0_{—}1.Z, . . . , 0_n.Z, 0_{—}1.A_{—}1, . . . , 0_n.A_m, ES_{—}1, . . . ES_n>,

whereby 0_i, 1≦i≦n, m>=n represents the relevant object and Z the actual state of the object.

A_j, 1<=j<=m is the current value of the particular attribute of the relevant object and

ES_i is the input queue of o_i.

This means that the state (all attribute values) and the input queue of all objects belongs to each model state.

The trace set is the set of all sequences

{[M_a, (O.Z_a, O.Z_b, M_z)),

with M_a being the initial state of the model and M_z the last state before discontinuation of the simulation and (O.Z_a, O.z_b) a transition of the object O from Z_a to Z_b.

The execution of actions, the occurrence of events etc is not recorded but can instead be detected by the change in the model state.

The results of the attainability analysis using the measuring system model as an example are as follows:

Input:

Set of potential deadlock situations after sorting={{Con.Measurement1, Sn1.Fetch_Time, U.Current, Sn2.Measure}}

Output:

| | | |
|---|---|---|
| Path List_User | = | {(Start, Observe)} |
| Path list_Con | = | ({Parameterizing, Measurement1)} |
| Path list_Sn1 | = | {(Measure, Fetch_Time)} |
| Path list_Sn2 | = | { } |
| Path list_U | = | {(Parameterizing, Current)} |

Trace_Set={<User.Start,Con.Parameterizing, Sn1.Measure,
Sn2.Measure,U.Parameterizing, Con.A.Measured value1 = 99.9,
Con.A.Measured value2 = 99.9, Sn1.A.Current = 999, U.A.Time
stamp = 999,
User.ES=[ ], Con.ES=[ ], Sn1.ES=[ ], Sn2. ES=[ ], U.ES=[ ]>,
(User.Start, User.Observe), <User.Observe,
Con.Parameterizing, Sn1.Measure, Sn2.Measure.U.Parameterizing,
Con.A.Measured value1 = 99.9, Con.A.Measured value2 = 99.9,
Sn1.A.Current = 999, U.A.Time stamp = 999, User.ES =[ ],
Con.ES=[Start], Sn1.ES=[ ], Sn2.ES=[ ], U.ES=[ ]>,
(Con.Parameterizing, Con.Measurement1), > User.Observe,
Con.Measurement1, Sn1.Measure, Sn2.Measure, U.Parameterizing,
Con. A.Measured value1 = 99.9, Con.A.Measured value2 = 99.9,
Sn1.A.Current = 999, U.A Time stamp = 999, User.ES =[ ],
Con.ES=[ ]
Sn1.ES=[Request_Measure Value], Sn2.ES = [ ], U.ES=[Start] >,
(U.Parameterizing.U.Current), <User.Observe, Con.
Measurement1,
Sn1.Measure, Sn2.Measure, U.Current, Con.A.Measured
value1=99.9,
Con.A.Measured value2 = 99.9, Sn1.A.Current=999, U.A.Time
stamp = 999,
User.ES = [ ], Con.ES=[ ], Sn1.ES=[Request_Measured Value],
Sn2.ES=[ ],
U.ES=[ ]>, (SN1.Measure, Sn1.Fetch_Time), <User.Observe,
Con.Measurement1, Sn1.Fetch_Time, Sn2.Measure, U.Current,
Con.A.Measured value1 = 99.9, Con.A.Measured value 2 = 99.9,
Sn1.A.Current = 999, U.A.Time stamp = 999, User.ES=[ ], Con.
ES=[ ],
Sn1.ES=[ ], Sn2.ES=[ ], U.ES= [Request_Time Stamp_Sensor1]>}

In phase d) the results of the analysis are then presented. The visualization of the method results depends on the system developer having thorough UML knowledge and experience in system modeling. The essential presentation means in this case is the known sequence diagram that enables the sequence of the messages in which the deadlock situation occurs to be very well presented.

FIG. 10 shows the sequence diagram for the results of the attainability analysis using the examined measuring system model as an example.

In the example, the messages participating in the deadlock situation were represented by the graphic symbol _----------, that stands for the <<deadlock>> stereotype.

A frame with rounded corners serves to optically combine the messages participating in the deadlock. In addition, the states of the objects participating in the deadlock are shown in a notice box.

Example embodiments being thus described, it will be obvious that the same may be varied in many ways. Such variations are not to be regarded as a departure from the spirit and scope of the present invention, and all such modifications as would be obvious to one skilled in the art

1. Method for determining deadlocks in secondary processes with at least one object in one state waiting for a different object in a specific state, for a system model of a reactive system described in an object-oriented manner, the method comprising:
a) extracting all active objects of the object-oriented system model;
b) determining at least the events consumed and/or produced by the active object, transition between the objects and guard conditions of state machines of the system model for describing the state relations of the objects;
c) generating the state-wait relation between the active objects from the determined results, as lists of objects that wait in a defined state for a different object in a defined state;
d) determining potential deadlocks as cycles of entities of two or more different objects that wait for each other, with no object in the cycle being involved in more than one state and none of the objects of the cycle waiting for an object outside the cycle; and
for each determined deadlock situation:
e) checking of all possible paths that lead to a determined deadlock and from which state machines of the system model can be derived, by simulated execution of the system model taking account of events and activated transitions for analysis of the attainability of the determined potential deadlock.

2. Method according to claim 1, wherein, in step a) of the extradition of all active objects, the active objects are extracted from a static and dynamic structural view of the system model and stored in an object list.

3. Method according to claim 1, wherein, for each active object, an assigned class is stored in a class list and, for each class in the class list, the associated state diagram is evaluated for specification of a state machine and the specified state machines are stored in a state machine list.

4. Method according to claim 1, wherein the determination of the potential deadlock situations takes place by means of a known depth-first search method.

5. Method according to claim 1, wherein the verification of the attainability of the determined potential deadlock situations takes place heuristically in that, starting from an initial state of the system model, the particular activated transitions are determined and that activated transition is chosen that brings the system model nearer to the deadlock situation.

6. Method according to claim 5, wherein activated transitions are present if the guard condition for the assigned object is true and the event of the object lies in an input queue.

7. Method according to claim 1, wherein step e) of the checking of all potential paths for each deadlock situation is iteratively performed until either a deadlock situation is attained or all paths are run through a specified number of times.

8. Method according to claim 1, wherein the system and model is described using the Unified Modeling Language.

9. Computer program with program code segments for performing the method in accordance with claim 1, when the computer program is run on a computer.

10. Method according to claim 2, wherein, for each active object, an assigned class is stored in a class list and, for each class in the class list, the associated state diagram is evaluated for specification of a state machine and the specified state machines are stored in a state machine list.

11. Method according to claim 2, wherein the determination of the potential deadlock situations takes place by means of a known depth-first search method.

12. Method according to claim 2, wherein step e) of the checking of all potential paths for each deadlock situation is iteratively performed until either a deadlock situation is attained or all paths are run through a specified number of times.

13. Method according to claim 2, wherein the system and model is described using the Unified Modeling Language.

14. A computer readable medium including program segments for, when executed on a computer device, causing the computer device to implement the method of claim 1.

15. A method for determining deadlocks in secondary processes for a system model that is described in an object-oriented manner, the method comprising:
a) extracting all active objects of the object-oriented system model;
b) identifying the transitions between the objects;
c) establishing state-waiting relations between the objects;
d) determining potential deadlocks as cycles of entities of two or more different objects, which wait for each other; and
e) for each deadlock, verifying all potential paths resulting in a determined deadlock by way of simulated execution of the system model.

16. A computer readable medium including program segments for, when executed on a computer device, causing the computer device to implement the method of claim 15.
